(19) United States
(12) Patent Application Publication
(10) Pub. No.: US 2006/0065642 A1
(43) Pub. Date: Mar. 30, 2006

(54) Bonding apparatus using conductive material

(75) Inventors: Osamu Shindo, Tokyo (JP); Satoshi Yamaguchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/234,191

(22) Filed: Sep. 26, 2005

(30) Foreign Application Priority Data
Sep. 29, 2004 (JP) 2004-282924

(51) Int. Cl. B23K 26/20

(52) U.S. Cl. 219/121.63

(57) ABSTRACT

The present invention provides a bonding apparatus in which solder is conveyed onto a predetermined electrode, and the solder is melted by irradiation of a laser beam and is bonded to the electrode and has an object to prevent the solder from adhering to a solder conveying system of the apparatus. To achieve the above object, in the bonding apparatus, a film having low wettability to the solder and having a predetermined thickness such as a DLC film is coated on a region and a neighborhood of a solder holding and conveying member, which is contacted with the solder.

This application claims priority from Japanese Patent Application No. 2004-282924 filed on Sep. 29, 2004, which is hereby incorporated by reference herein.

### BACKGROUND OF THE INVENTION

1. Field of the Invention

The present invention relates to a bonding apparatus using conductive material such as solder and, more particularly, it relates to a bonding apparatus, using conductive material, suitable for performing minute bonding represented by bonding between a bonding pad formed on a slider of a magnetic head and a pad formed on a lead frame.

2. Related Background Art

In the past, a bonding method in which, after a solder ball is installed between electrodes to be bonded, the solder ball is melted by irradiation of a laser beam, thereby achieving electrical connection between the electrodes was already known.

FIG. 2 is a sectional view of a conventional bonding apparatus in which connection between electrodes is performed by using a solder ball. As shown in FIG. 2, a bonding apparatus 1 as a first conventional example is provided with a tapered nozzle 2. In the nozzle 2, it is set so that an inner diameter of an opening at a distal end of the nozzle communicated with a space within the nozzle becomes greater than at least an outer diameter of a solder ball 3 to be melted. That is to say, the solder ball 3 fed into the interior of the nozzle 2 can be separated from the distal end of the nozzle. Further, a laser radiating unit (not shown) is disposed near a rear end of the nozzle. A laser beam 7 from the laser radiating unit can melt the solder ball 3 held between electrodes 6 formed on a slider 4 and flexor 5 which are bonded together.

Further, the bonding apparatus is not limited to the above-mentioned apparatus, but another bonding apparatus is also known. FIG. 3 is a sectional view of a bonding apparatus as a second conventional example in which electrodes are connected to each other by using a solder ball. Incidentally, in the second conventional example, members similar to or same as those in the first conventional example are designated by the same reference numerals.

As shown in FIG. 3, similar to the first conventional example, a bonding apparatus 8 according to the second conventional example comprises a tapered nozzle 2 and a laser radiating unit (not shown) disposed above the nozzle 2. However, an inner diameter of at a distal end of the nozzle 2 is smaller than a diameter of a solder ball 3 and the interior of the nozzle 2 is connected to suction means (not shown). By operating the suction means, the solder ball 3 can be sucked from the distal end of the nozzle 2 and can be held at the distal end of the nozzle 2. In the bonding apparatus 8 having such an arrangement, after the solder ball 3 is picked up from a solder ball supplying device (not shown) and is shifted onto electrodes 6, the solder ball 3 is melted by irradiation of a laser beam, thereby performing connection between the electrodes 6. In this case, the distal end of the nozzle 2 acts as a mask for the laser beam, so that the laser beam passed through the opening of the mask or nozzle can melt the solder ball 3.

As an arrangement in which the laser beam is irradiated through the mask so that the laser beam irradiates onto only a portion required to be soldered, a technique disclosed in Japanese Utility Model Application Laid-Open No. 6-41174 is known. Further, a technique including a step of discharging particles of molten solder (solder balls) onto electrodes and a step of then irradiating a laser beams onto the solder particles and the electrodes, thereby improving a bonding ability of the solder to the electrodes (for example, refer to Japanese Patent Application Laid-open No. 2002-76043) and a technique in which a discharging port for shield gas is elongate slit-shaped an optical axis of a laser beam is positioned within the discharging port for the shield gas (for example, refer to Japanese Patent Application Laid-open No. 2003-204149) are known.

In a step for handling molten solder, in case of an arrangement having any element adapted to hold solder and heated to a temperature same as that of the solder or more, for example such as a nozzle disclosed in the above-mentioned Japanese Utility Model Application Laid-Open No. 6-41174, adhesion of the solder to such an element must be avoided. Further, in case of the arrangement disclosed in the above-mentioned Japanese Patent Application Laid-open No. 2002-76043, both adhesion of the solder to a nozzle itself during the discharging of the solder particles from the nozzle and scattering of the solder during irradiation of the laser beam must also be considered. If such adhesion of the solder occurs, the inner diameter of the nozzle is decreased, with the result that a solder supplying amount is decreased as the operating time is increased, and, in an extreme case, the supplying itself of the solder may become difficult.

### SUMMARY OF THE INVENTION

The present invention is made in consideration of the above-mentioned problems and an object of the present invention is to provide a bonding apparatus in which molten conductive material such as molten solder can be prevented from adhering to a nozzle and the like and a conductive ball such as a solder ball can be supplied preferably and stably.

To solve the above problems, the present invention provides a bonding apparatus in which conductive material is supplied to an electrode and a laser beam is irradiated onto the conductive material to melt the conductive material, thereby bonding the conductive material to the electrode, the bonding apparatus comprising a nozzle adapted to hold the conductive material and capable of resting the conductive material on a conductive material bonding position on the electrode, and a laser radiating device for irradiating a laser beam onto the conductive material positioned at the bonding position, and the bonding apparatus being characterized in that a region of the nozzle with which the conductive material contacts is coated by a film having an insulating property and a low wettability to the conductive material and being hard to be adhered by the molten conductive material.

Incidentally, in the above-mentioned bonding apparatus, it is preferable that the film be made of DLC in the view point of wettability to the conductive material, insulating property and easiness of film formation. Further, in the above-mentioned bonding apparatus, it is preferable that the nozzle has an internal space which can be ventilated and which is communicated with an opening provided in the nozzle and the conductive material is held via the opening. In this case, it is preferable that the laser radiating device can be installed with a predetermined positional relationship to the nozzle and the laser beam is irradiated onto the conductive material through at least one of the internal space and the opening of the nozzle. Further, it is preferable that the conductive material is sucked and held via the opening of the nozzle.

Concretely, the present invention takes measures in which the conductive material is hard to be adhered or bonded to the distal end of the nozzle. As simple and effective measures, it is considered that the distal end of the pick-up nozzle, more concretely, a portion of the nozzle which is apt to be contacted with the conductive material is coated by a material having low wettability to the molten conductive material. As such a material, carbon-based materials are preferable. In general, the carbon-based material has low wettability to molten metal and can easily be coated by a CVD method, a PVD method or the like. Further, a DLC film (diamond-like carbon film) including carbon as a main material has excellent strength and anti-wear ability, as well as low wettability, and also has a property capable of being easily peeled in layers. Thus, by coating the DLC film on the distal end of the pick-up nozzle, possibility that the molten conductive material is adhered to the distal end of the nozzle is reduced, and, if the conductive material is adhered to the distal end, the portion to which the conductive material is adhered will be peeled in a layer. Consequently, adhesion of the conductive material can be prevented effectively.

In the present invention, as mentioned above, the coating layer made of the material having low wettability to the molten conductive material is applied to the portion which is apt to be contacted with the molten conductive material. Due to the presence of the coating layer, the molten conductive material can effectively be prevented from adhering to the nozzle and conductive balls can be supplied properly. Further, by using DLC as the coating material, the coating layer can always be maintained as an outermost layer by making use of the special layer-like peeling property of DLC. Accordingly, the effect of the coating layer can be sustained for a longer time.

Incidentally, in a case where fine conductive balls are used, it is known that static electricity is accumulated on the conductive balls by the action of friction, particularly friction between the conductive balls in a conductive ball reservoir during the supplying of the conductive balls. Further, also regarding the nozzle made of a conductive material such as so-called ultra-hard alloy, it is known that some potential is given to the nozzle by various motions. If the conductive ball is held by such a nozzle and is contacted with or approached to near the electrode to be bonded, all of electrical charges accumulated on the nozzle and the conductive ball will try to flow into the electrode. If electric current generated in this way is great, there is the possibility of occurrence of so-called ESD (electrostatic destruction) which destroys various circuits connected to the object to be bonded.

The DLC film is known to have a high specific resistance value of 10⁻² to 10⁻¹⁰ Ωm. Accordingly, by coating the DLC film on the distal end of the pick-up nozzle, electrical resistance between the pick-up nozzle and the conductive ball is increased, thereby generating a secondary effect that the electric current flowing from the pick-up nozzle to the conductive ball is reduced greatly. Therefore, due to the coating of the DLC film, the possibility of occurrence of the electrostatic destruction during the bonding operation is also reduced greatly.

Although solder is suitable as the conductive material in the present invention, gold, ally or other conductive materials can be used.

The above and other objects, features and advantages of the invention will become more apparent from the following detailed description taken in connection with the accompanying drawings.

### BRIEF DESCRIPTION OF THE DRAWINGS

FIG. 1 is an explanatory view showing a condition that a conductive ball is melted on an electrode area by using a conductive ball bonding apparatus according to an embodiment of the present invention;

FIG. 2 is a view showing a first conventional example of a bonding apparatus for performing connection between electrodes by using a conductive ball; and

FIG. 3 is a view showing a second conventional example of a bonding apparatus for performing connection between electrodes by using a conductive ball.

### DESCRIPTION OF THE PREFERRED EMBODIMENTS

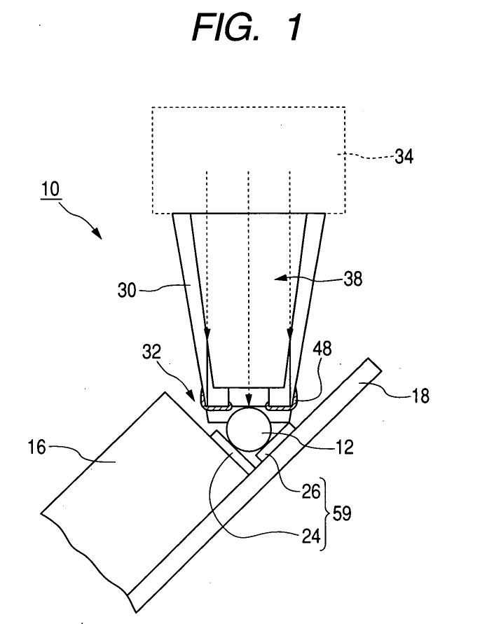

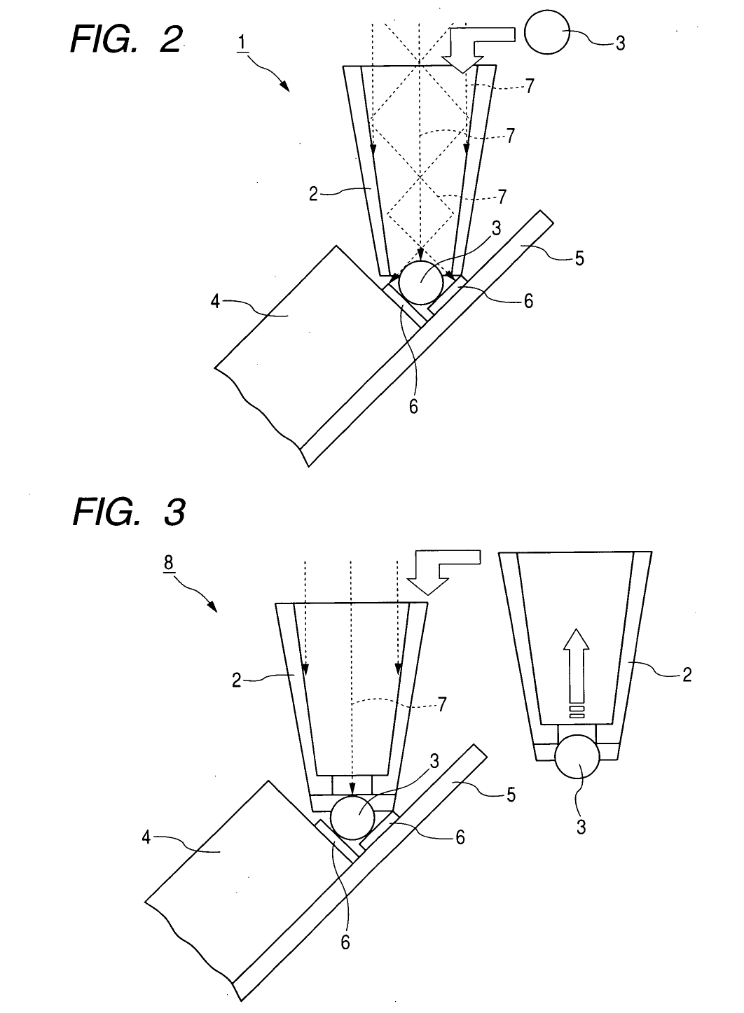

Now, a preferred concrete embodiment of a solder ball bonding apparatus according to the present invention will be fully explained with reference to the accompanying drawings. In the embodiment, solder is used as an example of the conductive material. FIG. 1 is an explanatory view showing a condition that a solder ball is melted on an electrode area by using a solder ball bonding apparatus according to an embodiment of the present invention.

As shown in FIG. 1, a solder ball bonding apparatus 10 according to the illustrated embodiment can be shifted reciprocally, by shifting means (not shown), between a supplying device (not shown) for supplying a solder ball 12 and magnetic head constituting parts which are objects to be bonded. Incidentally, the magnetic head constituting parts described here are a slider 16 into which GMR elements and the like are embedded, and a flexor 18 for supporting the slider 16.

By the way, in the illustrated embodiment, slider side electrodes 24 are formed on the slider 16, and the number of flexor side electrodes 26 corresponding to the number of the slider side electrodes are provided. The slider side electrode 24 and the flexor side electrode 26 are arranged in such a manner that edges thereof abut against each other and the electrodes are in perpendicular to each other. In other words, a V-shaped groove is defined between the electrode 24 and the electrode 26. These electrodes 24 and 26 constitute an electrode area 59 to be bonded by the solder ball.

The bonding apparatus 10 reciprocally shifted between the supplying device and the magnetic head mainly comprises a conical cylinder 30 forming a main body of the apparatus, a pick-up nozzle 32 disposed below the conical cylinder, and a laser radiating unit 34 disposed at a side of the conical cylinder 30 opposite to the pick-up nozzle 32. An internal space 38 is provided within the conical cylinder 30. The internal space 38 is connected to air feeding and discharging means and nitrogen gas supplying means (not shown) as inert gas supplying means. By the air feeding and discharging means, it is possible to perform an operation for generating suction through the pick-up nozzle 32 by reducing pressure in the internal space, an operation for generating so-called vacuum rupture to release a reduced pressure environment within the internal space 38 to atmospheric pressure or an operation for injecting the nitrogen gas through the pick-up nozzle 32 by feeding the nitrogen gas into the internal space 38. A DLC film 48 is formed in the vicinity of an opening of the pick-up nozzle 32.

In the pick-up nozzle 32, by forming the DLC film 48 on an area which is actually contacted with the solder ball, adhesion of the solder particularly molten solder to the pick-up nozzle 32 can be prevented effectively. Further, by providing the DLC film having high specific resistance on the region of the pick-up nozzle 32 contacted with the solder ball, electrical charges can be prevented from flowing from the nozzle to the solder ball. Incidentally, in FIG. 1, while an example that the coating is applied to only the distal end surface of the pick-up nozzle was shown, preferably, the DLC film is coated on any regions which may be contacted with the solder ball or on a member for supporting the solder ball.

Now, a procedure for bonding the slider side electrode 24 formed on the slider 16 of the magnetic head to the flexor side electrode 26 formed on the flexor 18 by using the solder ball bonding apparatus so constructed will be explained. Incidentally, here, the solder ball 12 used in the connection between the slider side electrode 24 and the flexor side electrode 26 is a small or fine ball having an outer diameter of about 80 to 150 microns.

In the bonding operation in the magnetic head, first of all, the bonding apparatus 10 is shifted toward the solder ball supplying device and the solder ball 12 positioned in the supplying device is sucked by the pick-up nozzle 32 to shift the solder ball 12 to the pick-up nozzle 32. After the bonding apparatus 10 is shifted up to the solder bonding position, the air feeding and discharging means are operated to return the pressure in the internal space 38 to the atmospheric pressure (vacuum rupture), and then, the nitrogen gas is introduced into the internal space 38 by the nitrogen gas supplying means, thereby injecting the nitrogen gas from the pick-up nozzle 32. Further, while maintaining a condition that the nitrogen gas is being injected, the laser radiating unit 34 is operated to irradiate the laser beam 50 toward the solder ball 12.

By irradiating the laser beam 50 onto the solder ball 12 and the electrodes 24 and 26 through the opening of the pick-up nozzle 32, the solder ball 12 can be melted and, at the same time, the electrodes 24 and 26 can be heated. That is to say, when the electrodes 24 and 26 are heated, a temperature difference between the molten solder (solder ball before melt) and the electrodes can be decreased, with the result that the wettability of the solder can be enhanced. Thus, reliability of the electrical connection of the electrode area 59 i.e. electrical connection between the slider side electrode 24 and the flexor side electrode 26 can be enhanced.

Incidentally, the coating may also be applied to an inner surface of the through opening of the nozzle. Since the pick-up nozzle contacts with the solder and holds the solder, when the solder ball is melted, the molten solder may enter into the interior of the through opening of the nozzle. Since the laser beam is irradiated at and around the through opening, the temperature of the irradiated region is increased to the extent same as the temperature of the molten solder. Thus, the molten solder entered in the through opening may be adhered to the heated region to clog the through opening. By coating the DLC film on such a region as well, the possibility of occurrence of such clogging can be reduced greatly. Further, it is also supposed that the solder ball is abruptly melted by the irradiation of the laser beam and a part of the molten solder is scattered. Thus, it is preferable that the area to be coated is determined in consideration of such circumstances.

Further, in the illustrated embodiment, while an example that the DLC film is used as the preferable coating film was explained, the present invention is not limited to such an example. It is considered that any material having low wettability to the used conductive material and a high resistance value, i.e. insulation material can be used as the coating film in the present invention. Concretely, silicon, nitrides and oxides of silicon system, nitride of boron system or the like can be used. Further, in the present invention, films such as DLC films are coated on the region to which the conductive material may be adhered or the region where the conductive ball may be contacted with or electrically communicated with the nozzle, and the configuration of the bonding apparatus is not limited to that shown in the illustrated embodiment. That is to say, the present invention may be applied to bonding apparatuses shown in the first and second conventional examples.

More specifically, the nozzle may hold the conductive ball by electrostatic suction or absorption, as well as the vacuum suction. In this case, it is supposed that, if the conductive material is adhered to the sucking surface, when the further conductive ball is held, the holding position or holding posture may be changed. By applying the present invention to a nozzle performing the electrostatic suction, a nozzle having a constant sucking surface can be provided. Further, an irradiating direction of the laser beam may not necessarily coincide with a direction passing through the interior of the nozzle. The present invention may be applied to a bonding apparatus in which, after the conductive ball is supplied, a laser beam is irradiated from a direction different from a conductive ball holding direction. In the arrangement in which the laser beam is irradiated from the direction different from the holding direction, it is supposed that a scattering range of the molten conductive material becomes greater than that in the illustrated embodiment. In this case, by further widening or increasing the coating areas, a preferred apparatus environment capable of reducing the adhesion of the molten conductive material can be maintained.

In the above-mentioned embodiment, as the bonding apparatus according to the present invention using the solder, the apparatus achieving the bonding between the bonding pad formed on the slider of the magnetic head and the pad formed on the lead frame was described. However, the application of the present invention is not limited to such bonding apparatus, but, the present invention can be applied to all of apparatuses in which solder is conveyed in the vicinity of objects to be bonded by means of a member made of ultra-hard alloy and the solder is melted abruptly by a laser beam, for example, such as the apparatus described in the above-mentioned Japanese Patent Application Laid-open No. 2002-76043. In this case, the coating may be applied to a portion of the solder conveying member with which the solder may be contacted.

As many apparently widely different embodiments of the present invention can be made without departing from the sprit and scope thereof, it is to be understood that the invention is not limited to the specific embodiment thereof except as defined in the appended claims.

What is claimed is:

1. A bonding apparatus in which conductive material is supplied to an electrode and a laser beam is irradiated onto said conductive material to melt said conductive material, thereby bonding said conductive material to said electrode, comprising:
a nozzle adapted to hold said conductive material and capable of resting said conductive material on a conductive material bonding position on said electrode; and
a laser radiating device for irradiating a laser beam onto said conductive material positioned at said bonding position;
and wherein
at least a region of said nozzle with which said conductive material contacts is coated by a film having an insulating property and a low wettability to said conductive material and being hard to be adhered by molten conductive material.

2. A bonding apparatus according to claim 1, wherein said film comprises a diamond-like carbon film (DLC film).

3. A bonding apparatus according to claim 1, wherein said nozzle has an internal space which can be ventilated and which is communicated with an opening provided in said nozzle, and said conductive material is held via said opening.

4. A bonding apparatus according to claim 3, wherein said laser radiating device can be installed with a predetermined positional relationship to said nozzle and the laser beam is irradiated onto said conductive material through at least one of said internal space and said opening.

5. A bonding apparatus according to claim 4, wherein said conductive material is sucked and held via said opening of said nozzle.
